(19) United States
(12) Patent Application Publication
(10) Pub. No.: US 2011/0212207 A1
(43) Pub. Date: Sep. 1, 2011

(54) Dough Rounder

(76) Inventors: Andrew D. Voyatzakis, Carlisle, MA (US); George Athanasiadis, Lexington, MA (US)

(21) Appl. No.: 13/036,694

(22) Filed: Feb. 28, 2011

Related U.S. Application Data
(60) Provisional application No. 61/309,153, filed on Mar. 1, 2010.
(60) Provisional application No. 61/366,572, filed on Jul. 22, 2010.

(51) Int. Cl. A21C 3/02; A21C 11/00

(52) U.S. Cl. 425/332

(57) ABSTRACT

A dough rounder with a base, motor, turntable, drum, and auger. The auger mounts to the base and the drum mounts to the turntable to rotate about the auger. The auger has a hollow cylindrical center. Dough dropping into the auger strikes a flexible plate extending at an angle from the cylinder wall. The plate deflects downwardly when struck by the dough and pushes the dough out of an opening in the side of the cylinder when it rebounds.

### CROSS-REFERENCES TO RELATED APPLICATIONS

The present application claims the benefit of and priority to U.S. Provisional Patent Application No. 61/309,153, filed on Mar. 1, 2010 for DOUGH ROUNDER in the names of Andrew Voyatzakis and George Athanasiadis, hereby incorporated by reference in its entirety, and U.S. Provisional Patent Application No. 61/366,572, filed on Jul. 22, 2010 for DOUGH ROUNDER in the names of Andrew Voyatzakis and George Athanasiadis, hereby incorporated by reference in its entirety.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to dough preparation, more particularly, to machines for rolling dough into balls.

2. Description of the Related Art

Rounding is an important step in the baking process. The prior art includes a number of different apparatuses for rounding dough. One type of dough rounder is describe in U.S. Pat. No. 3,899,275. An auger consists of a spiral ramp rigidly secured to the outer wall of a tubular cylinder and is mounted to a base. A cylindrical drum is mounted to rotate about the auger such that the outer edges of the ramp are contiguous to the inner wall of the drum. The ramp is inclined downwardly and outwardly across its width to push pieces of dough on the ramp against the inner wall of the drum. A fixed dispenser plate at the bottom of the cylinder directs pieces of dough dropped down the cylinder through an opening in the side wall of the cylinder and on to the ramp. Rotation of the drum moves the dough upwardly on the ramp to the upper edge of the cylinder and drum. Constant pressure of the drum wall and the ramp on the dough rounds the dough as it moves to the top of the drum. The ramp stops at the upper edge of the drum and when the dough ball reaches the top of the rounder it drops over the edge of the drum onto a suitable surface.

There are several shortcomings with this design. The bottoms of the drum and auger are mounted to the base of the apparatus, with the auger on a post fixed to the base and the drum on a spindle that rotates around the auger. Because there is no side support for the drum, side to side motion of the drum is not prevented. As the dough travels up the auger, it presses against the inside of the drum. This has the effect of pushing the drum away from the auger a small amount, producing a gap on the order of 1/16 to ¼ inch where the dough is and pulling the drum into the auger on the opposite side. The constant rubbing of the drum against the auger as the drum rotates causes premature wear of the drum.

Correct operation of the dispenser plate relies on the dough being relatively moist. If the dough is too dry or sticky, it jams against the opening to the auger ramp or sticks on the dispenser plate, never reaching the ramp. Then the operator has to turn the machine off and reach down into the auger cylinder to release the dough.

### BRIEF SUMMARY OF THE INVENTION

The basic dough rounder of the present invention has a base and housing, a motor with the gearing, control, and power, a turntable, a drum, an auger, and a cover. The drum is mounted to the turntable and the auger is mounted to the base. When the motor rotates the turntable, the drum rotates around the auger. The cover mounts on top of the auger and drum.

The dough rounder of the present invention has several differences from rounders of the prior art, including the drum and auger mounting mechanism, two improved dispenser designs, and a swappable dough tray.

The drum and auger mounting mechanism, which includes a lower mounting mechanism and an upper mounting mechanism, substantially prevents lateral motion of the drum relative to the auger. In one configuration of the lower mounting mechanism, a vertical shaft from the bottom of the auger fits into an opening in the base that is only slightly larger than the shaft so that there is minimal lateral motion of the auger. In another configuration of the lower mounting mechanism, a vertical pin extending upwardly from an opening in the base fits into an opening in the bottom of the auger that is only slightly larger than the pin so that there is minimal lateral motion of the auger. In another configuration, an annular extension on the bottom of the auger fits into an annular gap on the turntable that is only slightly wider than the thickness of the annular extension so that there is minimal lateral motion of the auger. In all configurations, the bottom end of the drum is open to fit around the turntable. Protrusions from the turntable fit into notches in the bottom drum, thereby attaching causing the turntable to support the drum and the drum to rotate with the turntable.

In one configuration of the upper mounting mechanism, a pair of collar support rods extend upwardly from the base to support a collar. The collar has a round opening slightly larger than the outside diameter of the drum. Support rods extend upwardly from the collar above the collar support rods. In another configuration of the upper mounting mechanism, a pair of support rods extend upwardly from the base. A collar fits over the support rods. The collar has a round opening slightly larger than the outside diameter of the drum. The auger has a pair of horizontal handles. In one configuration, each handle has an aperture that fits around the knobs at the top of the support rods. In another configuration, the ends of the handles fit into semicircular walls on the top of the supports rods. When the auger is inserted into the drum, the handle apertures are aligned with the knobs or the handles are aligned with the walls and then lowered until the apertures fit onto the knobs or the handles fit into the walls, thereby capturing the handles to prevent lateral motion and supporting the weight of the auger.

The conical dispenser mechanism has a conical projection extending upwardly from the center of the turntable, with an angle from horizontal in the range of from approximately 40° to approximately 60°. A scraper, in two embodiments, is mounted to the auger cylinder wall. The first embodiment is a solid with a hollow that surrounds a majority of the side wall of the conical projection, leaving one portion facing the side opening of the cylinder exposed. The scraper surface has an angle from horizontal in the range of from approximately 40° to approximately 60°. The second embodiment of the scraper is a spatula with a generally parabolic edge that surrounds and abuts the conical projection side wall. The spatula surface has an angle from horizontal that is in the range of from approximately 45° to approximately 65°. The spatula has a bracket that securely mounts it to the cylinder surface opposite the cylinder side opening.

The flexible dispenser plate has a plate with a smooth surface that extends at an angle from a bracket. The bracket is either permanently or removably mounted to the cylinder wall opposite the cylinder side opening. Alternatively, the bracket is suspended from the top edge of the auger by a hook. The plate/bracket junction is flexible such that when the dough strikes plate, the plate deflects downwardly and pushes the dough out of the cylinder when the plate rebounds. The plate surface 160 has an unflexed angle to horizontal in the range of from approximately 45° to approximately 70°. Optionally, a spring between the bracket and cylinder wall provides greater rebound.

The dough balls exiting from the drum/auger are directed to a swappable dough tray. The top surface of the housing over the motor compartment is a flat shelf and the top of the drum/auger compartment overhangs the shelf by a small amount. The tray rests on the shelf with the tray lip under the overhang. The tray's weight retains it in place.

### BRIEF DESCRIPTION OF THE DRAWINGS

For a fuller understanding of the nature and object of the present invention, reference is made to the accompanying drawings, wherein:

FIG. 1 is a perspective, partial cutaway view of the dough rounder of the present invention;

FIG. 2 is an exploded view of one embodiment of the dough rounder of FIG. 1;

FIG. 3 is an exploded view of another embodiment of the rounder of FIG. 1;

FIG. 4 is a side view of the dough rounder of the FIG. 1 without the drum;

FIG. 5 is an exploded view of one configuration of the auger portion of the lower mounting mechanism of the drum/auger mounting mechanism;

FIG. 6 is a view of another configuration of the auger portion of the lower mounting mechanism of the drum/auger mounting mechanism;

FIG. 7 is an exploded view of another configuration of the auger portion of the lower mounting mechanism of the drum/auger mounting mechanism;

FIG. 8 is a cross-sectional view of the auger portion of the lower mounting mechanism configuration of FIG. 7;

FIG. 9 is an exploded view of the drum portion of the lower mounting mechanism;

FIG. 10 is an exploded side view of one configuration of the upper mounting mechanism of the drum/auger mounting mechanism;

FIG. 11 is an exploded side view of another configuration of the upper mounting mechanism of the drum/auger mounting mechanism;

FIG. 12 is a partial, perspective view of another configuration of the upper mounting mechanism of the drum/auger mounting mechanism;

FIG. 13 is an exploded view of the solid scraper embodiment of the conical dispenser of the present invention;

FIG. 14 is a cross-sectional side view of the conical dispenser of FIG. 13;

FIG. 16 is an exploded view of the spatula scraper embodiment of the conical dispenser of the present invention;

FIG. 16 is a cross-sectional side view of the conical dispenser of FIG. 15;

FIG. 17 is partial cutaway, perspective view of the flexible dispenser of the present invention;

FIG. 18 is a cross-sectional side view of the flexible dispenser of FIG. 17;

FIG. 19 is a cross-sectional side view of the flexible dispenser of FIG. 17 showing several options;

FIG. 20 is a cross-sectional side view of another method of mounting the flexible dispenser;

FIG. 21 is a cross-sectional side view of another method of mounting the flexible dispenser; and

FIG. 22 is a cross-sectional side view of another method of mounting the flexible dispenser.

### DETAILED DESCRIPTION OF THE INVENTION

The basic dough rounder 10 of the present invention is shown in the figures. It has a base 12 and housing 13, a motor 14 with the attendant gearing 24, control 26, and power (not shown) in a housing 15, a turntable 16, a drum 18, an auger 20, and a cover 22. The housing 13 has two compartments, the motor compartment 15 and the drum/auger compartment 21. The gearing 24 operatively connects the motor 14 to the turntable 16 and has a cover 25 for protection and safety. The motor compartment 15 has a removable panel 27 and the drum/auger compartment has a hinged panel 23. The auger 20 is a cylinder 19 with a spiral ramp 30 rigidly secured to the outer wall.

As with prior art dough rounders, the motor 14, via the gearing 24, rotates the turntable 16 on a vertical axis. The drum 18 is mounted to the turntable 16 and the auger 20 is mounted to the base 12 inside the drum 18. The outer rim of the auger ramp 30 engages with the inner surface 28 of the drum 18. When the motor 14 is actuated, the drum 18 rotates around the auger 20. The optional cover 22 mounts on top of the auger 20 and drum 18.

The dough rounder 10 of the present invention has several differences from rounders of the prior art, each of which constitutes a separate invention. The differences include the mechanism by which the drum 18 and auger 20 are mounted, three improved dispenser designs, and a swappable dough tray 26.

A. Drum/Auger Mounting Mechanism

The drum 18 and auger 20 mounting mechanism of the present invention substantially prevents the lateral motion of the auger 20 and the drum 18 relative to each other. There are two components to the mounting mechanism, the lower mounting mechanism 34 and the upper mounting mechanism 36. The lower mounting mechanism 34 substantially prevents lateral motion of the bottom of the drum 18 and auger 20 relative to each other. The upper mounting mechanism 36 substantially prevents lateral motion of the top of the drum 18 and auger 20 relative to each other and holds the auger 20 fixed relative to the base 12 so that the drum 18 rotates about the auger 20.

One configuration of the lower mounting mechanism 34 is shown in FIG. 5. An opening 40 in the base 12 receives a vertical shaft 42 from the bottom of the auger 20. The opening 40 is slightly larger than the shaft 42 so that there is minimal lateral motion of the auger 20. The turntable 16 is rotationally mounted to the base 12 and has a central hole 44 through which the shaft 42 reaches the opening 40. The turntable hole 44 is large enough that the turntable 16 freely rotates around the shaft 42.

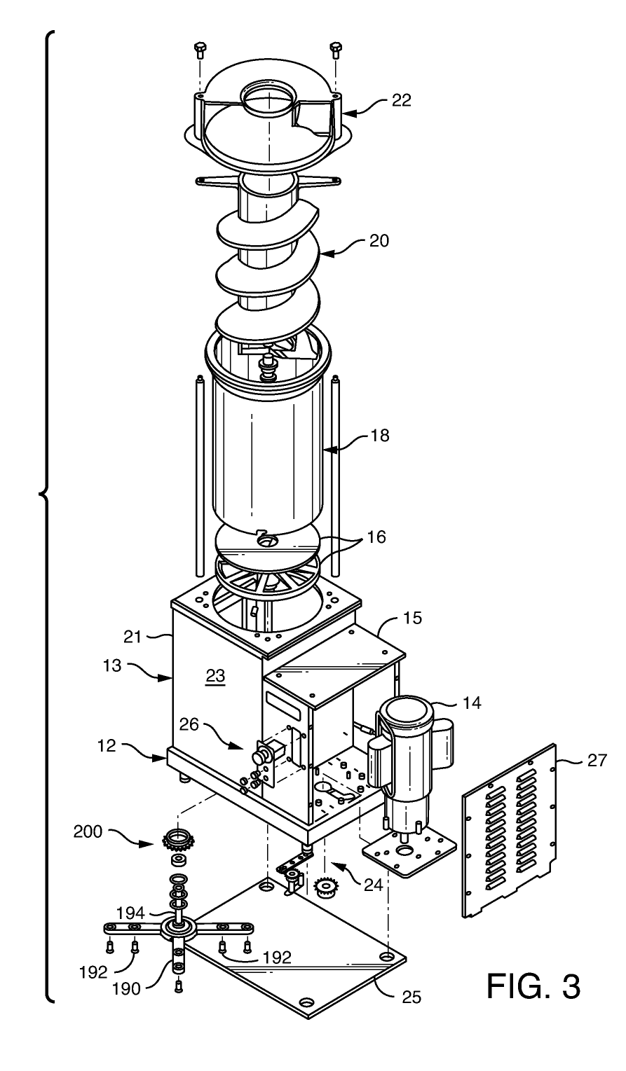

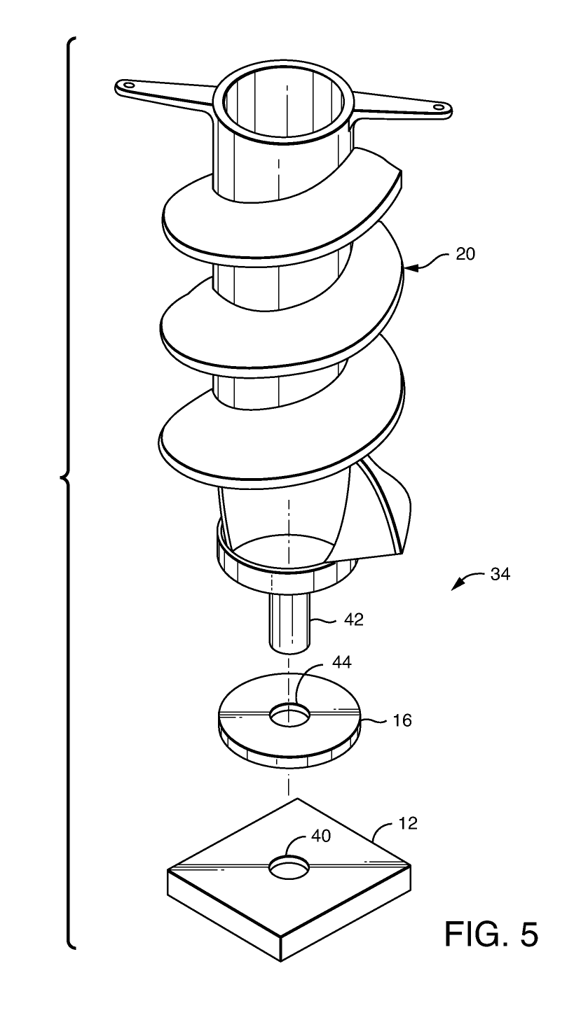

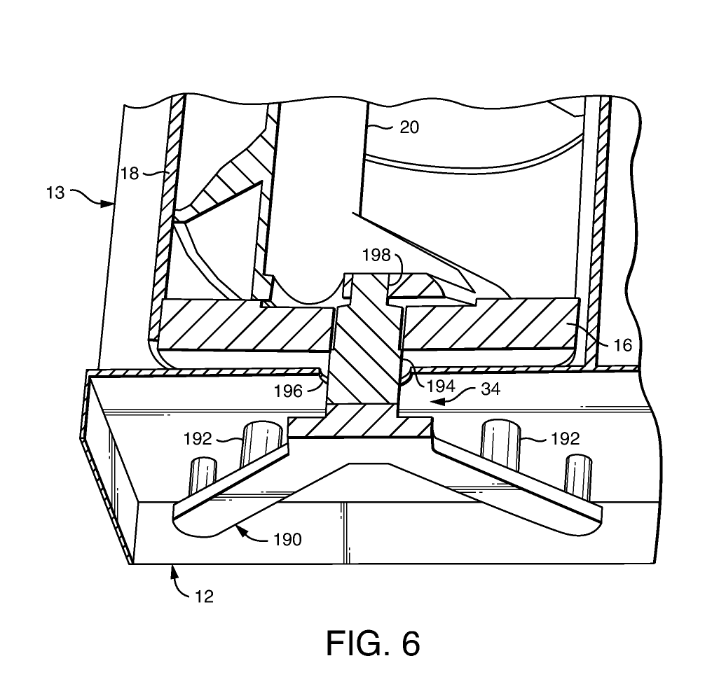

Another configuration of the lower mounting mechanism 34 is shown in FIGS. 3 and 6. An X-shaped bracket 190 is attached to the underside of the base 12 via screws 192. A pin 194 extends upwardly into the drum/auger compartment 21 through an opening 196 in the base 12. The pin 194 fits into an opening 198 in the bottom of the auger 20. The auger opening 198 is slightly larger than the pin 194 so that there is minimal lateral motion of the auger 20 relative to the pin 194. Optionally, although not specifically related to the lower mounting mechanism 34, gearing 200 attached to the turntable 16 uses the pin 194 as an axle. This gearing 200 is driven by the motor gearing 24 to turn the turntable 16.

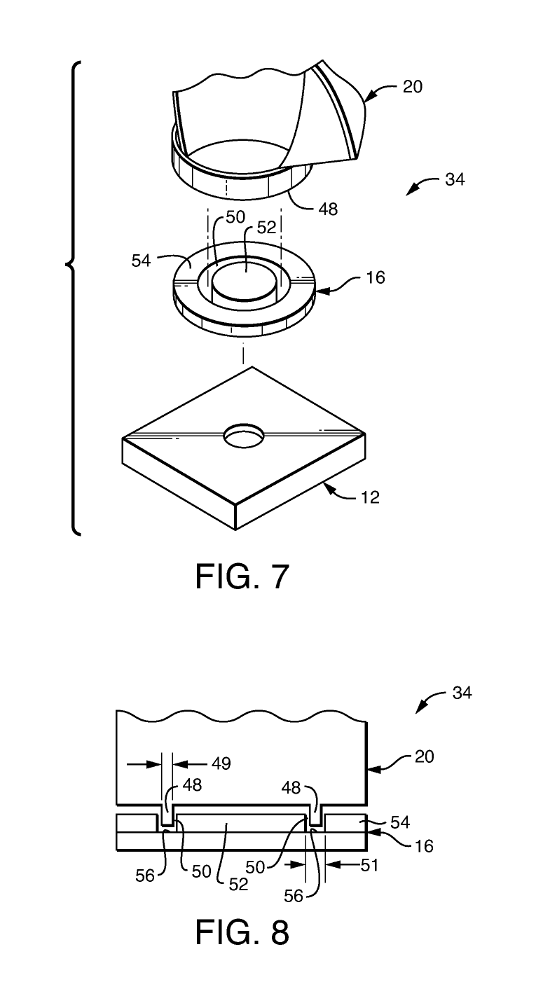

Another configuration of the lower mounting mechanism 34 is shown in FIGS. 7 and 8. An annular extension 48 on the bottom of the auger 20 is received by an annular groove 50 on the turntable 16 formed by an inner disk 52 and an outer ring 54. The groove 50 has a width 51 that is slightly larger than the thickness 49 of the annular extension 48. As the turntable 16 rotates, the annular extension 48 slides within the groove 50. The walls of the groove 50 formed from the inner disk 52 and the outer ring 54 substantially prevents lateral motion of the auger 20 relative to the drum 18.

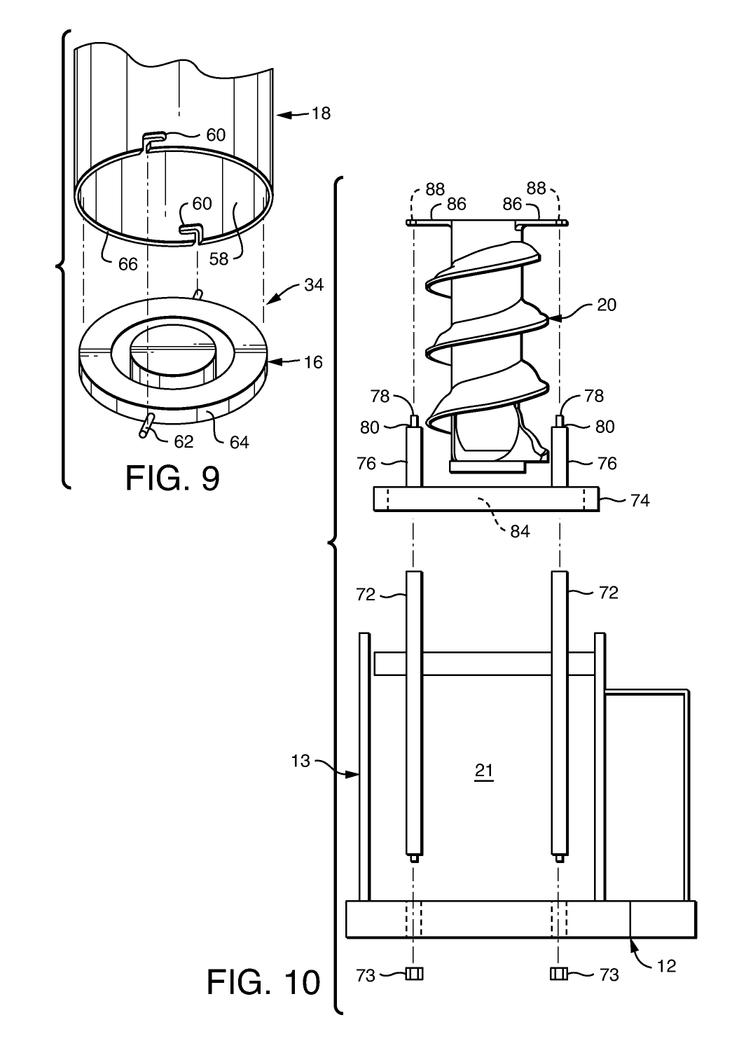

In all configurations of the lower mounting mechanism 34, the bottom end of the drum 18 is open, as at 58 in FIG. 9. The opening 58 fits around the outer rim 64 of the turntable 16. Protrusions 62 extending horizontally from the turntable rim 64 fit into notches 60 in the bottom rim 66 of the drum 18, thereby attaching the drum 18 to the turntable 16 and causing the drum 18 to rotate with the turntable 16.

One configuration of the upper mounting mechanism 36 is shown in FIG. 10. A pair of collar supports 72 extends upwardly from the base 12 and held by nuts 73. The collar supports 72 support a collar 74. The collar 74 has a round opening 84 that is coaxial with the turntable 16. The opening 84 is slightly larger than the outside diameter of the drum 18. Extending upwardly from the collar 74 above the collar supports 72 are support rods 76. At the top end of the support rod 76 is a knob 78 of smaller diameter, producing a horizontal shoulder 80.

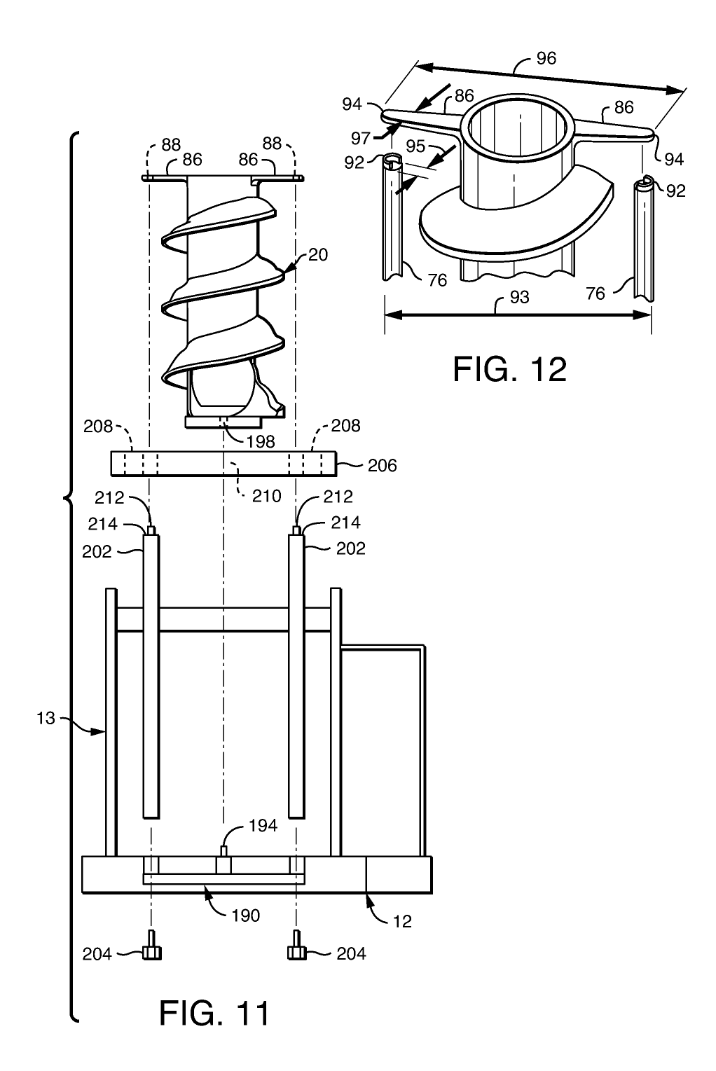

Another configuration of the upper mounting mechanism 36 is shown in FIG. 11. A pair of support rods 202 extends upwardly from the base 12 and held by nuts 204 through the X-shaped bracket 190. A collar 206 has openings 208 for the support rods 202 so that the collar 206 slides onto the support rods 202. The collar 206 has a round opening 210 that is coaxial with the turntable 16. The opening 210 is slightly larger than the outside diameter of the drum 18. At the top end of each support rod 202 is a knob 212 of smaller diameter, producing a horizontal shoulder 214.

The auger 20 has a pair of horizontal handles 86 extending from opposite sides of the auger 20 adjacent to (at or near) the top end of the cylinder 19. There may be more than two handles. At the end of each handle 86 is an aperture 88 that has a diameter the slightly larger than the diameter of the knob 78, 212. The distance between the two apertures 88 is the same as the distance between the two knobs 78, 212.

Alternatively, as shown in FIG. 12, rather than knobs 78, 212, there are semicircular walls 92 at the top of each support rod 76, 202. The largest distance between the two inner surfaces 93 of the walls 92 is the same as the distance 96 between the ends of the handles 86. The distance 95 between the two ends of the wall 92 is slightly larger than the width 97 of the end of the handle 86.

The drum 18 is installed by inserting it into the collar opening 84, 210, aligning the notches 60 with the protrusions 62, and lowering the drum 18 until the protrusions 62 are in the notches 60. The auger 20 is inserted into the drum 18 and rotated until either the handle apertures 88 are aligned with the knobs 78, 212 or the handle ends 94 are aligned with the inside of the walls 92. The auger 20 is lowered further into the drum 18 until either the handle apertures 88 fit onto the knobs 78, 212 or the handle ends 94 fit into the walls 92 and the handles 86 rest on the support rods 76, 202. The knobs 78, 212 or walls 92 removably attach the handles 86 to the support rods 76, 202, capturing the handles 86 to prevent the auger 20 from rotating relative to the base 12.

As described above, the handles 86 are supported by the support rods 76, 202. However, the present invention contemplates that the handles 86 may be supported by any apparatus that can support the weight of the auger 20. The support may be walls, rather than rods, that extend upwardly from the base 12. The support rods 76, 202 or other support apparatus is generally referred to as auger supports.

As the handles 86 are being lowered onto the support rods 76, 202, the lower mounting mechanism 34 is also engaged, either the auger mounting shaft 42 is within the base opening 40 of FIG. 5, the pin 194 is within the auger opening 198 of FIG. 6, or the auger annular extension 48 is within the groove 50 of FIG. 7. The auger supports 76, 202 support the weight of the auger 20 so that, in the configurations of FIGS. 5 and 6, the auger 20 is held just above the turntable 16 or, in the configuration of FIG. 7, the annular extension 48 at the bottom of the auger 20 rides in the groove 50 just above the groove floor 56, as in FIG. 8.

Because of the lateral support provided to the drum 18 and the auger 20 by the mounting mechanism 34, 36, the drum 18 and auger 20 do not substantially move laterally relative to each other, greatly reducing wear on the drum 18 as compared to the dough rounders of the prior art.

B. Conical Dispenser Mechanism

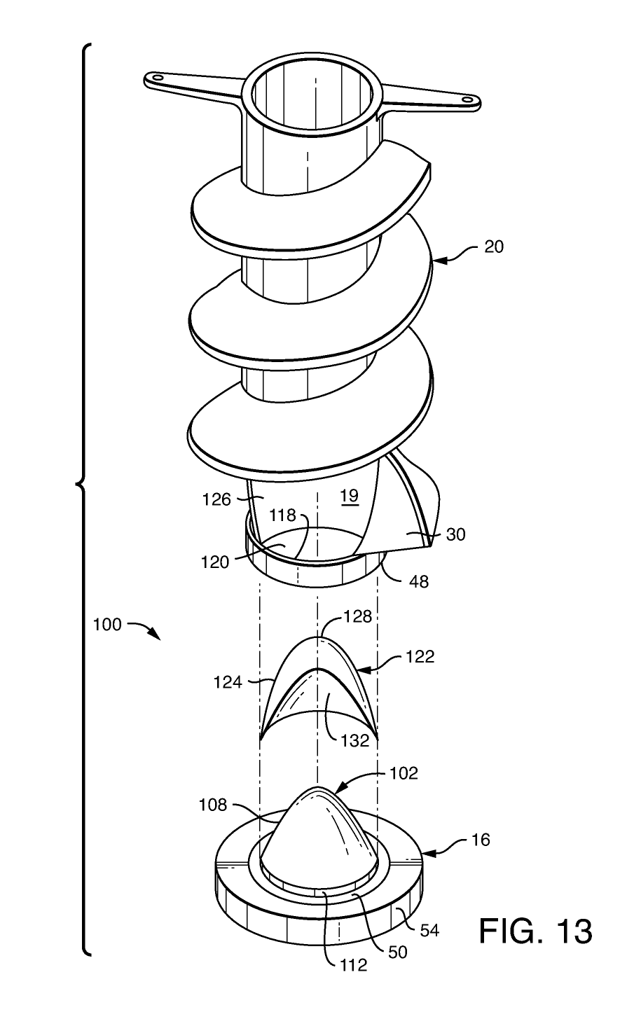

As described above, dough can become stuck on the fixed dispenser plates of the prior art. The conical dispenser mechanism 100 of the present invention is one design for preventing dough from becoming stuck and is shown in FIGS. 13-16. A conical projection 102 extends upwardly from the center of the turntable 16. In order to direct to dough into the auger ramp 30 properly, the side wall 108 of the conical projection 102 has an angle from horizontal 110 that is in the range of from approximately 40° to approximately 60°, and is preferably in the range of from approximately 47° to approximately 53°.

The conical dispenser mechanism 100 is not compatible with the first configuration of the lower mounting mechanism 34 of FIG. 5 because the conical projection 102 does not allow the turntable 16 to have the center hole 44. Consequently, the conical dispenser mechanism 100 is used with the third configuration of the lower mounting mechanism 34 of FIGS. 7 and 8. The inner disk 52 is replaced by the conical projection 102 so that the outer rim 112 of the conical projection 102 forms the groove 50 with the outer ring 54.

The bottom of the auger cylinder 19 is open, as at 120 and the conical projection 102 extends into the opening 120 when the auger 20 is installed in the drum 18.

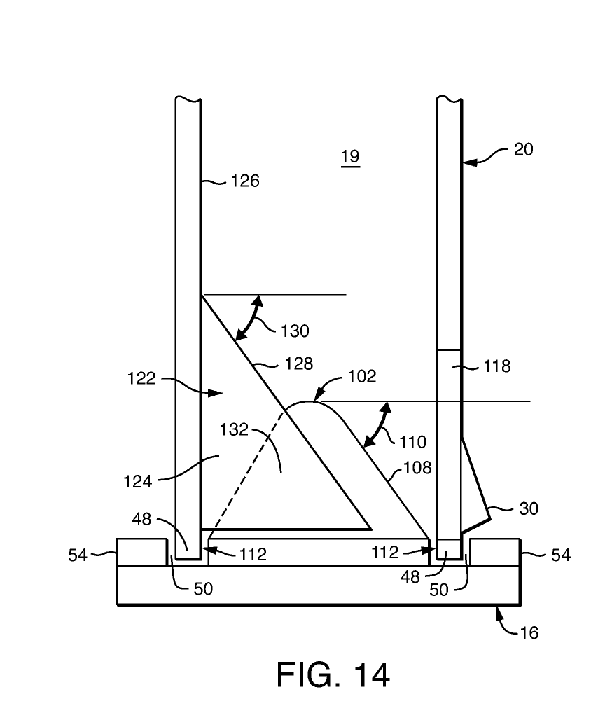

Securely mounted to the cylinder wall 126 is a scraper 122 that has two embodiments. The first embodiment, shown in FIGS. 13 and 14, is a solid with a hollow 132 that surrounds a majority of the side wall 108 of the conical projection 102, leaving one portion exposed. The exposed portion faces the side opening 118 of the cylinder 19. In order to properly direct the dough onto the auger ramp 30, the scraper surface 128 has an angle from horizontal 130 that is in the range of from approximately 40° to approximately 60°, and is preferably in the range of from approximately 47° to approximately 53°.

In the second embodiment, shown in FIGS. 15 and 16, the scraper 122 is a spatula 136 with a generally parabolic edge 138 that surrounds and abuts the side wall 108 of the conical projection 102. In order to properly direct the dough onto the auger ramp 30, the spatula surface 140 has an angle from horizontal 142 that is in the range of from approximately 45° to approximately 65°, and is preferably in the range of from approximately 50° to approximately 60°. The spatula 136 has a bracket 146 that extends vertically and that securely mounts to the cylinder surface 126 opposite the side opening 118 of the cylinder 19.

Because the scraper 122 is attached to the auger cylinder wall 126 and the conical projection 102 is attached to the turntable 16, the conical projection 102 rotates within the scraper 132. As dough falls down the cylinder 19, it hits the rotating conical projection wall 108. As the conical projection 102 rotates, the wall 108 moves the dough to the scraper 122. As the wall 108 passes under the scraper 122, the dough is scraped from the wall 108, directing it to the ramp 30.

C. Flexible Dispenser Plate

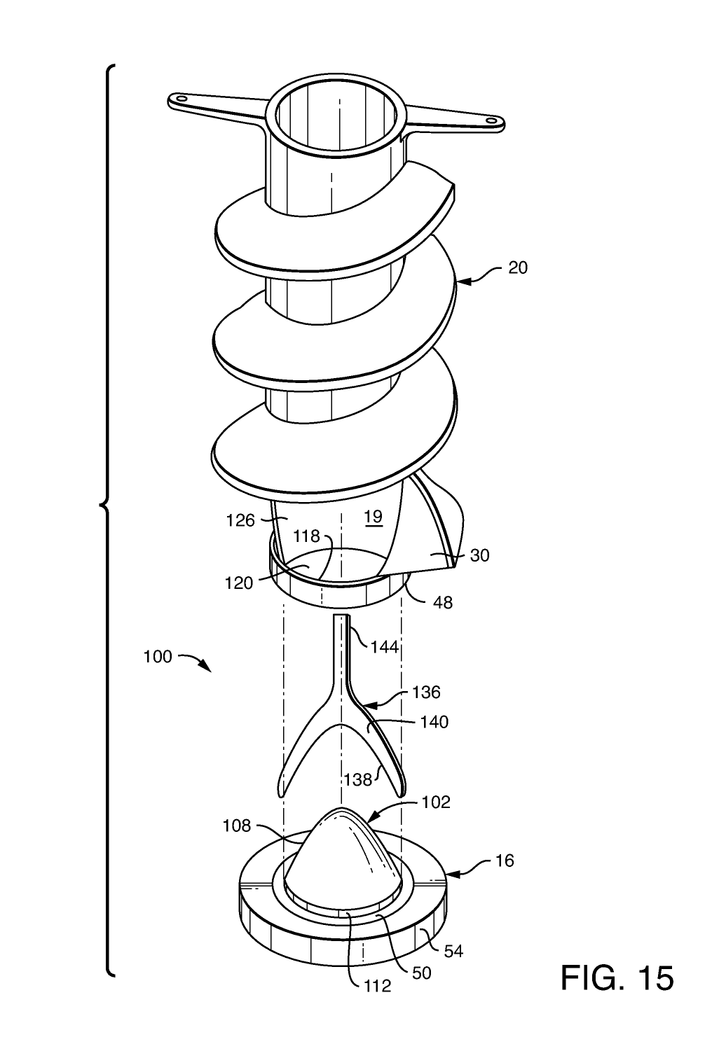

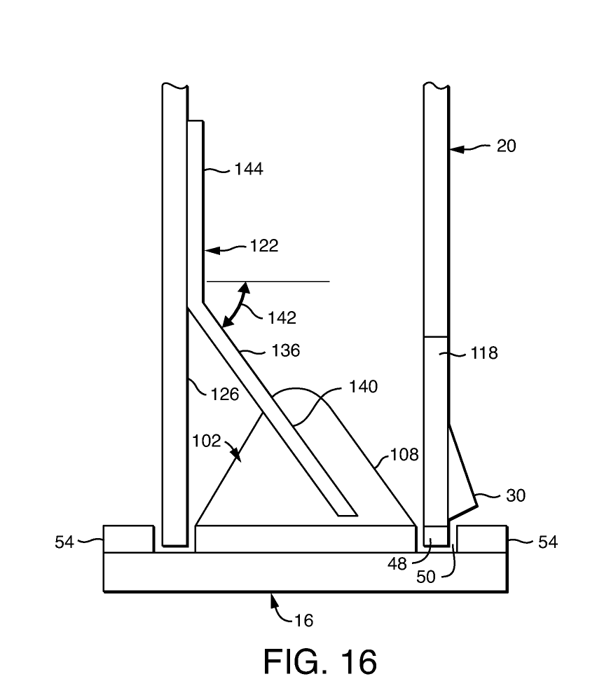

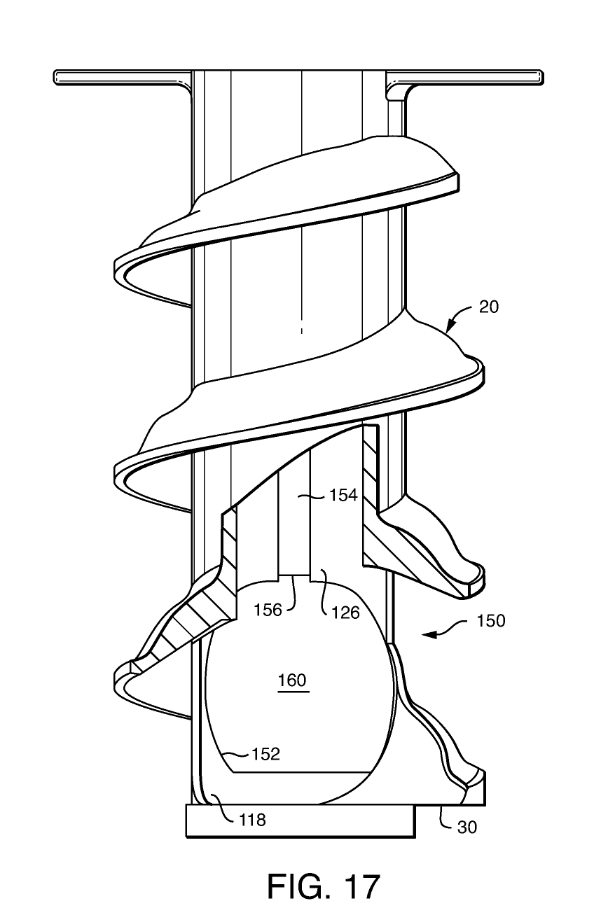

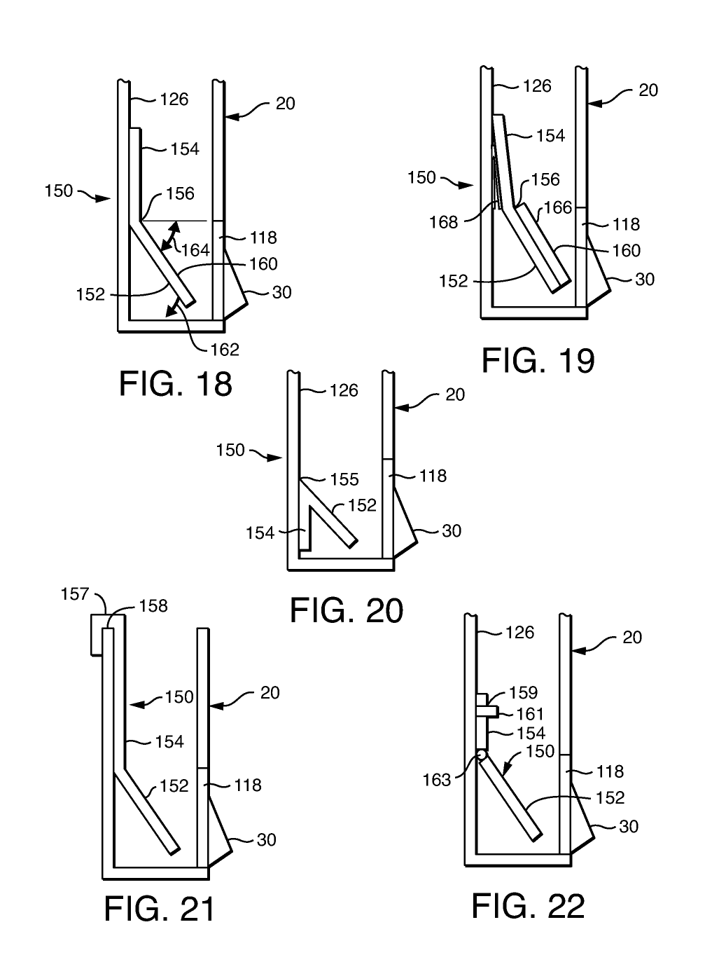

The flexible dispenser plate 150 of the present invention is another design for preventing dough from becoming stuck and is shown in FIGS. 17-22. A plate 152 with a smooth deflecting surface 160 extends at an angle 164 from a bracket 154. The bracket 154 can be mounted in one of several different ways. In one mounting method, shown in FIGS. 18 and 19, the bracket 154 that is attached to the cylinder wall 126 opposite the cylinder side opening 118. The attachment can be permanent, as with a weld, or it can be removable, as with a screw. In another mounting method, shown in FIG. 20, the bracket 154 bends downwardly, as at 155, and is attached either permanently or removably to the cylinder wall 126 opposite the cylinder side opening 118. In another mounting method, shown in FIG. 21, the bracket 154 includes a hook 157 that hangs from the upper edge 158 of the auger cylinder 19. In another mounting method, shown in FIG. 22, the bracket 154 includes a small aperture 159 that hangs on a protrusion 161 from the cylinder wall 126 opposite the cylinder side opening 118. A removable dispenser plate 150 can be cleaned and replaced more easily.

The plate/bracket junction 156 is relatively flexible such that when the dough strikes the deflecting surface 160 as it comes down the cylinder 19, the plate 152 deflects downwardly a short distance, as at 162. As the plate 152 rebounds upwardly, the deflecting surface 160 pushes the dough through the cylinder side wall opening 118 and onto the ramp 30.

The plate 152 and bracket 154 can be a unitary piece, such as a single metal sheet, as in FIGS. 17-21. The junction 156 includes a bend in the sheet that has some flex when the dough strikes the deflecting surface 160. Alternatively, deflector plate 150 can be made of separate plate 152 and bracket 154 attached by a stiff hinge 163, as in FIG. 22.

In order to properly direct the dough onto the auger ramp 30, the deflecting surface 160 has an unflexed angle 164 to horizontal that is in the range of from approximately 45° to approximately 70°, and is preferably in the range of from approximately 50° to approximately 60°.

Optionally, the deflecting surface 160 is smooth from a coating or layer 166 of a smooth or low-friction material, as in FIG. 19, so that the dough is less likely to stick.

Optionally, as shown in FIG. 19, a spring 168 between the bracket 154 and the cylinder wall 126 near the junction 156 provides greater rebound. Any type of spring 168 can be used, such as a leaf or coil spring.

D. Swappable Dough Tray

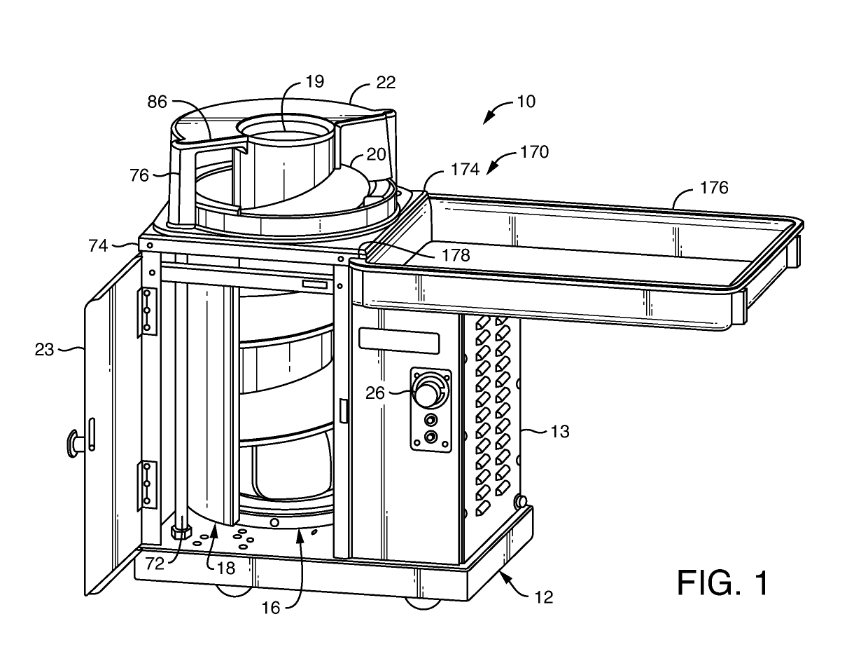

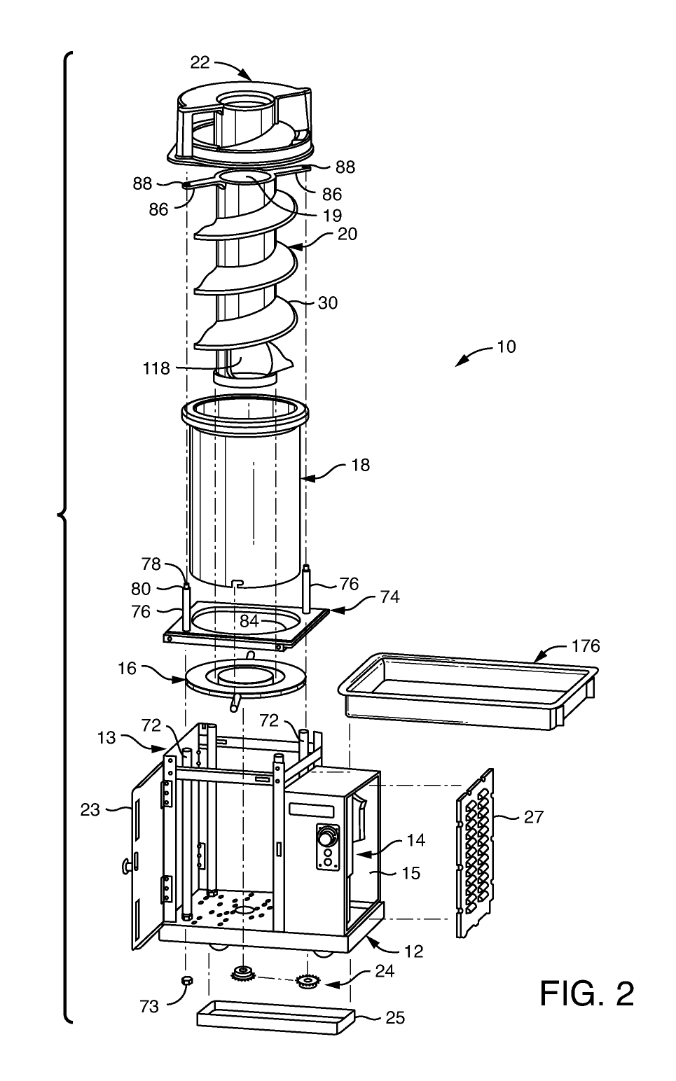

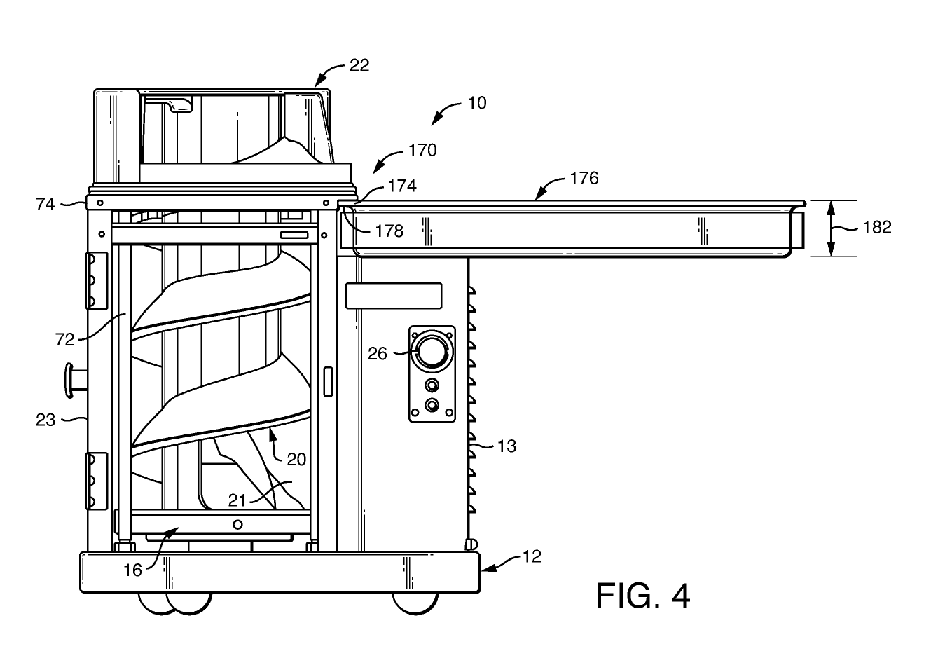

The dough balls exiting from the drum/auger are directed to a dough tray. The present invention provides a swappable dough tray 170 for a dough rounder. As seen in FIGS. 1 and 4, the top surface 172 of the housing 13 over the motor compartment 15 is a shelf that is smooth and flat. The top 180 of the drum/auger compartment 21, which may be the collar 74, overhangs the shelf 172 by a small amount, on the order of 1 to 3 inches. The vertical distance 182 between the shelf 172 and the overhang 174 generally defines the depth of the tray 176. The tray 176 rests on the shelf 172 with the lip 178 of the tray 176 under the overhang 174. The weight of the tray 176 levers the tray 176 so that the tray lip 178 pushes upwardly against the overhang 174, thereby retaining the tray 176 in place. To remove the tray 176, the free end 184 of the tray 176 is lifted slightly and the tray 176 is pulled out from under the overhang 174.

Thus it has been shown and described a dough rounder which satisfies the objects set forth above.

Since certain changes may be made in the present disclosure without departing from the scope of the present invention, it is intended that all matter described in the foregoing specification and shown in the accompanying drawings be interpreted as illustrative and not in a limiting sense.

What is claimed is:

1. A dough rounder comprising:
(a) a housing with base;
(b) a drum with an inner surface, said drum rotatably mounted vertically to said base;
(c) a mechanism for rotating said drum;
(d) an auger comprised of a tubular cylinder with an open top end, a bottom end, and a side wall with an outer surface and an opening in said side wall adjacent said bottom end, and a spiral ramp rigidly secured to said cylinder outer surface and having an outer edge, said auger being positioned within said drum with said ramp outer edge abutting said drum inner surface; and
(e) a dispenser plate within said cylinder and having a plate with a deflecting surface joined at a flexible junction to the end of a bracket attached to said cylinder;
(f) whereby, when dough that is dropped into said cylinder open top strikes said deflecting surface, said junction flexes downwardly and then rebounds, causing said deflecting surface to push said dough through said side wall opening onto said ramp.

2. The dough rounder of claim 1 wherein said bracket is removably attached to said cylinder.

3. The dough rounder of claim 2 wherein said bracket hangs by a hook.

4. The dough rounder of claim 1 wherein said plate and said bracket are composed of a single sheet, and said junction includes a bend in said sheet that flexes when said dough strikes said deflecting surface.

5. The dough rounder of claim 1 wherein said deflecting surface includes a smooth, lower-friction material.

6. The dough rounder of claim 1 wherein said deflecting surface is at an angle to horizontal in the range of from approximately 45° to approximately 70°.

7. The dough rounder of claim 1 wherein said deflecting surface is at an angle to horizontal in the range of from approximately 50° to approximately 60°.

8. A dough rounder comprising:
(a) a housing with base;
(b) a drum with an inner surface, said drum rotatably mounted vertically to said base;
(c) a mechanism for rotating said drum;
(d) an auger comprised of a tubular cylinder with an open top end, a bottom end, and a side wall with an outer surface and an opening in said side wall adjacent said bottom end, and a spiral ramp rigidly secured to said cylinder outer surface and having an outer edge, said auger being positioned within said drum with said ramp outer edge abutting said drum inner surface; and
(e) a dispenser plate within said cylinder, said dispenser plate being a single sheet with a plate and a bracket separated by a flexible junction that includes a bend in said sheet, said plate having a deflecting surface at an angle to horizontal in the range of from approximately 45° to approximately 70°;
(f) whereby, when dough that is dropped into said cylinder open top strikes said deflecting surface, said junction flexes downwardly and then rebounds, causing said deflecting surface to push said dough through said side wall opening onto said ramp.

9. The dough rounder of claim 8 wherein said bracket is removably attached to said cylinder.

10. The dough rounder of claim 9 wherein said bracket hangs by a hook.

11. The dough rounder of claim 8 wherein said deflecting surface includes a smooth, lower-friction material.

12. The dough rounder of claim 8 wherein said deflecting surface is at an angle to horizontal in the range of from approximately 50° to approximately 60°.
